(19) United States
(12) Patent Application Publication
(10) Pub. No.: US 2017/0061957 A1
(43) Pub. Date: Mar. 2, 2017

(54) METHOD AND APPARATUS FOR IMPROVING A LANGUAGE MODEL, AND SPEECH RECOGNITION METHOD AND APPARATUS

(71) Applicant: Kabushiki Kaisha Toshiba, Minato-ku (JP)

(72) Inventors: Pei DING, Beijing (CN); Kun YONG, Beijing (CN); Huifeng ZHU, Beijing (CN); Yutaka SATA, Beijing (CN); Jie HAO, Beijing (CN)

(73) Assignee: Kabushiki Kaisha Toshiba, Minato-ku (JP)

(21) Appl. No.: 15/247,079

(22) Filed: Aug. 25, 2016

(30) Foreign Application Priority Data
Aug. 28, 2015 (CN) 201510542215.0

(51) Int. Cl. G10L 15/06; G10L 15/26; G10L 15/183

(52) U.S. Cl. CPC G10L 15/063; G10L 15/183; G10L 15/26; G10L 2015/0633

(57) ABSTRACT

According to one embodiment, an apparatus for improving a language model of a speech recognition system includes an extracting unit, a classifying unit, and a setting unit. The extracting unit extracts user words from a user document provided by a user. The classifying unit classifies the user words based on a system lexicon of the speech recognition system. The setting unit sets weighting factor of a probability of the language model for at least one of the user words based on the classified result.

### CROSS-REFERENCE TO RELATED APPLICATION

This application is based upon and claims the benefit of priority from Chinese Patent Application No. 201510542215.0, filed on Aug. 28, 2015; the entire contents of which are incorporated herein by reference.

### FIELD

The present invention relates to a method for improving a language model of a speech recognition system, an apparatus for improving a language model of the speech recognition system, and a speech recognition method and a speech recognition apparatus.

### BACKGROUND

A speech recognition system commonly includes acoustic model and language model. Acoustic model is a model that collects statistics about probability distribution of acoustic feature relative to phoneme units, while language model is a model that collects statistics about occurrence probability of words sequences, and speech recognition process is essentially to obtain result with the highest score from weighted sum of probability scores of the two models.

In general speech recognition systems, the acoustic model and language model are fixed. When user documents provided by users are obtained in advance, such speech recognition systems cannot make targeted adjustments to the acoustic model and language model. However, language model of the speech recognition system is very sensitive to information such as the domain related to the application and words that may be used, so if the language model can be adjusted accordingly, speech recognition rate will be greatly improved for this application.

Although some speech recognition systems can register user-provided new words (out of system vocabulary) and key words (included by system vocabulary) and assign higher probabilities to these new words and key words by using a class-based language model, this still cannot efficiently improve the recognition rate for these new words and key words.

### BRIEF DESCRIPTION OF THE DRAWINGS

FIG. 1 is a diagram of a method for improving a language model of a speech recognition system according to an embodiment of the invention.

FIG. 2 is a diagram of a speech recognition method according to an embodiment of the invention.

FIG. 3 is a diagram of an apparatus for improving a language model of a speech recognition system according to an embodiment of the invention.

FIG. 4 is a diagram of a speech recognition apparatus according to an embodiment of the invention.

### DETAILED DESCRIPTION

According to one embodiment, an apparatus for improving a language model of a speech recognition system includes an extracting unit, a classifying unit, and a setting unit. The extracting unit extracts user words from a user document provided by a user. The classifying unit classifies the user words based on a system lexicon of the speech recognition system. The setting unit sets weighting factor of a probability of the language model for at least one of the user words based on the classified result.

Below, the embodiments of the invention will be described in detail with reference to drawings.

A Method for Improving a Language Model of a Speech Recognition System

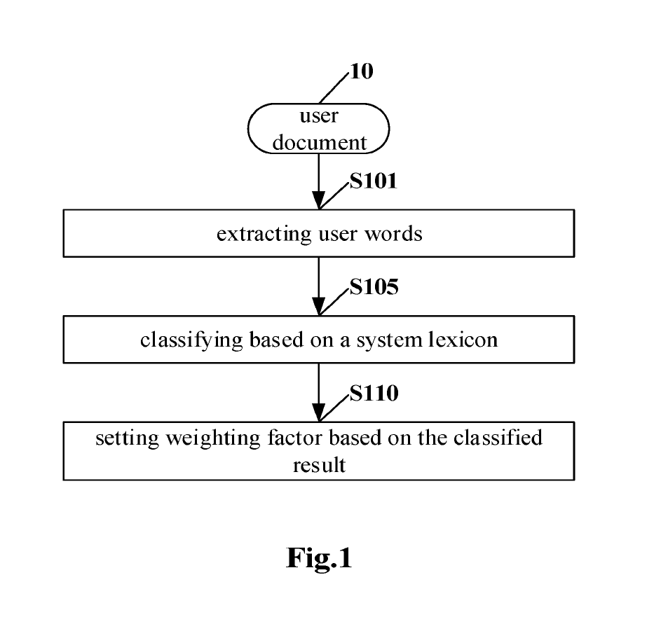

Detailed description is made in the following with reference to FIG. 1. FIG. 1 is a flowchart of a method for improving a language model of a speech recognition system according to an embodiment of the invention.

As shown in FIG. 1, first, in step S101, user words are extracted from a user document 10 provided by a user. Before application of speech recognition, users will provide some documents in advance. For example, in case of meeting assistant systems, the users will upload some meeting related documents to a system server in advance. Again, in case of lecture assistant systems, the users will upload lectures to a system server in advance. Here, such document provided by user in advance is referred to as ‘user document’. In this embodiment, the user document is not limited to the above meeting document or lecture, it may be any document provided by a user before application of speech recognition systems, and the present embodiment has no limitation thereto.

Any segmentation technique known to a person skilled in the art may be employed when extracting user words from the user document 10, and the present embodiment has no limitation thereto, which will not be described herein for brevity. Besides, users generally will also provide a user lexicon, which specifies words that will be definitely used in the application. When extracting user words, the extraction may also be performed based on the user lexicon. In this way, accuracy in extraction can be improved. For example, when “ [symbol] ”, which is a word that has never been used, is specified in the user lexicon, the “ [symbol] [symbol] ” can be precisely extracted as one word based on the user lexicon.

Next, in step S105, user words are classified based on a system lexicon of the speech recognition system. As one example, when user words are not included in the system lexicon, they are regarded as “new words”.

In addition, in case that user has provided a user lexicon, in step S105, preferably, based on both of the system lexicon and the user lexicon, the user words and words in the user lexicon are classified as ‘new words’, ‘key words’ and ‘other words’, the new words include words which are not included in the system lexicon, the key words include words which are included both in the system lexicon and the user lexicon, and the other words include words which are included in the system lexicon but not included in the user lexicon. In this way, corresponding weighting factor can be set based on class in subsequent step, and flexibility in the speech recognition system can be improved.

Next, in step S110, weighting factor b(W) of a probability P(W|*) of the language model is set for at least one of the user words based on the classified result. Specifically, the weighting factor b(W) is set to be more than 1. By setting the weighting factor b(W) to be more than 1, probability scores of the language model for the user words can be increased, thereby improving recognition rate thereof. In addition, in case that words in the user lexicon have also been classified in step S105, weighting factor of a probability of the language model may also be set for the words in the user lexicon.

In the present embodiment, it is preferable that weighting factor for the key words are set to be larger than that for the new words and other words. The key words are words included in the user lexicon, and the user lexicon has specified words that are definitely used by the user in the application. Thus, by setting weighting factor for the key word to be larger than that for the new words and other words, recognition rate of words that are definitely used by the user in the application can be efficiently improved.

In addition, since a large amount of user corpus has been accumulated by the speech recognition system during the long-term application, besides the above user words, weighting factor may also be set for words which are related with the user document 10 (referred to as ‘related words’ hereinafter) in a user corpus accumulated in the speech recognition system. By setting weighting factor for related words, recognition rate of the related words can be adjusted, and performance of the speech recognition system can be improved.

When setting weighting factor for related words, the setting may be performed based on at least one of domain correlation, word correlation and time correlation. Specifically, the higher the domain correlation is, the larger the weighting factor is set; the higher the word correlation is, the larger the weighting factor is set; and the higher the time correlation is, the larger the weighting factor is set.

Domain correlation means the probability of the words in some domain occurs together with the domain (information science, management of human resources, medical and healthcare and etc) of the user document 10, the higher the probability is, the higher the domain correlation is. Besides, word correlation means the probability of some word occurs together with the user words in the application, the higher the probability is, the higher the word correlation is. Besides, time correlation means degree of correlation in time. If some word in the accumulated user corpus frequently occurs in recent applications, it has very high probability to occur again in this application, thus time correlation is relatively high; on the contrary, if that word has not been used for a long time, the probability that it will occur in this application is relatively small, thus time correlation is low.

By deciding magnitude of weighting factor through considering at least one of domain correlation, word correlation and time correlation, recognition of words that have high relevance to user words is enhanced, recognition of words that have low relevance to user words is suppressed, and recognition rate of related words can be more precisely adjusted, thereby further improving performance of the speech recognition system. Here, the weighting factor set for related words may either be larger than 1 or below 1. When the weighting factor is larger than 1, it means that recognition rate of that related words is enhanced, on the other hand, when the weighting factor is below 1, it means that recognition rate of that related words will not be enhanced or is reduced.

The method for improving a language model of a speech recognition system of this embodiment, by setting weighting factor of a probability of the language model for at least one of the user words, is capable of efficiently improving recognition rate for user words. Further, by classifying the user words and words in the user lexicon as new words which are not included in the system lexicon, key words which are included both in the system lexicon and the user lexicon, and other words which are included in the system lexicon but not included in the user lexicon, it is capable of setting corresponding weighting factor based on class in subsequent step, and is capable of improving flexibility in the speech recognition system. Further, by setting weighting factor for the new words, key words and other words to be more than 1 respectively, it is capable of increasing probability scores of the language model for the new words, key words and other words, thereby improving recognition rate thereof. Further, by setting weighting factor for the key words to be larger than that for the new words and other words, it is capable of efficiently improving recognition rate of words that are definitely used by the user in the application. Further, by setting weighting factor for related words which are related with the user words in a user corpus accumulated in the speech recognition system, it is capable of adjusting recognition rate of the related words, thereby improving performance of the speech recognition system. Further, by deciding magnitude of weighting factor through considering at least one of domain correlation, word correlation and time correlation, recognition of words that have high relevance to user words is enhanced, recognition of words that have low relevance to user words is suppressed, and recognition rate of related words can be more precisely adjusted, thereby further improving performance of the speech recognition system.

Speech Recognition Method

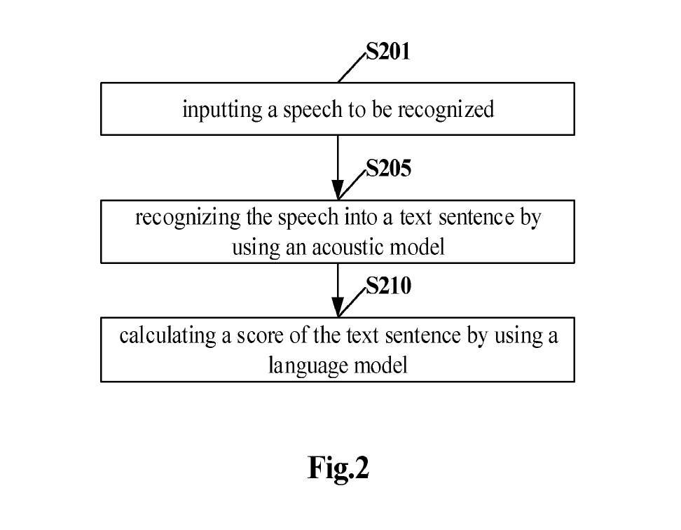

Detailed description is made in the following with reference to FIG. 2. FIG. 2 is a flowchart of a speech recognition method according to an embodiment of the invention.

First, in step S201, a speech to be recognized is input.

Next, in step S205, the speech is recognized into a text sentence by using an acoustic model. In the present embodiment, the acoustic model may be any acoustic model known to a person skilled in the art, the method of recognizing the speech into a text sentence by using an acoustic model may also be any recognition method known to a person skilled in the art, and the present embodiment has no limitation thereto.

Next, in step S210, a score of the text sentence is calculated by using a language model. Here, the language model used in the step S210 is a language model improved by the method for improving a language model of a speech recognition system.

The speech recognition method of the present embodiment, by using a language model improved by the method for improving a language model of a speech recognition system, is capable of achieving same technical effect as the method for improving a language model of a speech recognition system.

An Apparatus for Improving a Language Model of a Speech Recognition System

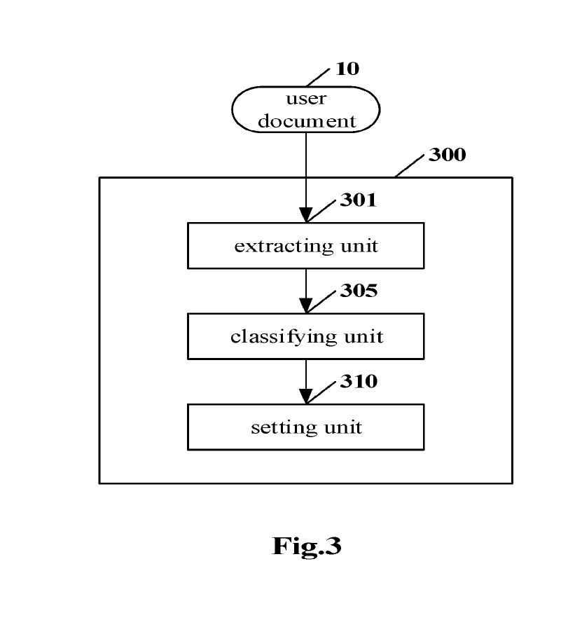

Detailed description is made in the following with reference to FIG. 3. FIG. 3 is a block diagram of an apparatus for improving a language model of a speech recognition system according to an embodiment of the invention.

As shown in FIG. 3, the apparatus 300 for improving a language model of a speech recognition system of the present embodiment is provided with an extracting unit 301, a classifying unit 305 and a setting unit 310.

User words are extracted by the extracting unit 301 from a user document 10 provided by a user. Before application of speech recognition, users will provide some documents in advance. For example, in case of meeting assistant systems, the users will upload some meeting related documents to a system server in advance. Again, in case of lecture assistant systems, the users will upload lectures to a system server in advance. Here, such document provided by user in advance is referred to as ‘user document’. In this embodiment, the user document is not limited to the above meeting document or lecture, it may be any document provided by a user before application of speech recognition systems, and the present embodiment has no limitation thereto.

Any segmentation technique known to a person skilled in the art may be employed when extracting user words from the user document 10 by the extracting unit 301, and the present embodiment has no limitation thereto, which will not be described herein for brevity. Besides, users generally will also provide a user lexicon, which specifies words that will be definitely used in the application. When extracting user words by the extracting unit 301, the extraction may also be performed based on the user lexicon. In this way, accuracy in extraction can be improved. For example, when “ [symbol] ”, which is a word that has never been used, is specified in the user lexicon, the “ [symbol] ” can be precisely extracted as one word based on the user lexicon.

User words extracted by the extracting unit 301 are classified by the classifying unit 305 based on a system lexicon of the speech recognition system. As one example, when user words are not included in the system lexicon, they are regarded as “new words” by the classifying unit 305.

In addition, in case that user has provided a user lexicon, preferably, based on both of the system lexicon and the user lexicon, the user words and words in the user lexicon are classified by the classifying unit 305 as ‘new words’, ‘key words’ and ‘other words’, the new words include words which are not included in the system lexicon, the key words include words which are included both in the system lexicon and the user lexicon, and the other words include words which are included in the system lexicon but not included in the user lexicon. In this way, corresponding weighting factor can be set based on class by the aftermentioned setting unit 310, and flexibility in the speech recognition system can be improved.

Weighting factor b(W) of a probability P(W|*) of the language model is set by the setting unit 310 for at least one of the user words based on the classified result of the classifying unit 305. Specifically, the weighting factor b(W) is set to be more than 1. By setting the weighting factor b(W) to be more than 1, probability scores of the language model for the user words can be increased, thereby improving recognition rate thereof. In addition, in case that words in the user lexicon have also been classified by the classifying unit 305, weighting factor of a probability of the language model may also be set for the words in the user lexicon.

In the present embodiment, it is preferable that weighting factor for the key words is set to be larger than that for the new words and other words. The key words are words included in the user lexicon, and the user lexicon has specified words that are definitely used by the user in the application. Thus, by setting weighting factor for the key word to be larger than that for the new words and other words, recognition rate of words that are definitely used by the user in the application can be efficiently improved.

In addition, since a large amount of user corpus has been accumulated by the speech recognition system during the long-term application, besides the above user words, weighting factor may also be set by the setting unit 310 for words which are related with the user document 10 (referred to as ‘related words’ hereinafter) in a user corpus accumulated in the speech recognition system. By setting weighting factor for related words, recognition rate of the related words can be adjusted, and performance of the speech recognition system can be improved.

When setting weighting factor for related words by the setting unit 310, the setting may be performed based on at least one of domain correlation, word correlation and time correlation. Specifically, the higher the domain correlation is, the larger the weighting factor is set; the higher the word correlation is, the larger the weighting factor is set; and the higher the time correlation is, the larger the weighting factor is set.

Domain correlation means the probability of the words in some domain occurs together with the domain (information science, management of human resources, medical and healthcare and etc) of the user document 10, the higher the probability is, the higher the domain correlation is. Besides, word correlation means the probability of some word occurs together with the user words in the application, the higher the probability is, the higher the word correlation is. Besides, time correlation means degree of correlation in time. If some word in the accumulated user corpus frequently occurs in recent applications, it has very high probability to occur again in this application, thus time correlation is relatively high; on the contrary, if that word has not been used for a long time, the probability that it will occur in this application is relatively small, thus time correlation is low.

By deciding magnitude of weighting factor through considering at least one of domain correlation, word correlation and time correlation, recognition of words that have high relevance to user words is enhanced, recognition of words that have low relevance to user words is suppressed, and recognition rate of related words can be more precisely adjusted, thereby further improving performance of the speech recognition system. Here, the weighting factor set for related words may either be larger than 1 or below 1. When the weighting factor is larger than 1, it means that recognition rate of that related words is enhanced, on the other hand, when the weighting factor is below 1, it means that recognition rate of that related words will not be enhanced or is reduced.

The apparatus for improving a language model of a speech recognition system of this embodiment, by setting weighting factor of a probability of the language model for at least one of the user words, is capable of efficiently improving recognition rate for user words. Further, by classifying the user words and words in the user lexicon as new words which are not included in the system lexicon, key words which are included both in the system lexicon and the user lexicon, and other words which are included in the system lexicon but not included in the user lexicon, it is capable of setting corresponding weighting factor based on class in subsequent step, and is capable of improving flexibility in the speech recognition system. Further, by setting weighting factor for the new words, key words and other words to be more than 1 respectively, it is capable of increasing probability scores of the language model for the new words, key words and other words, thereby improving recognition rate thereof. Further, by setting weighting factor for the key words to be larger than that for the new words and other words, it is capable of efficiently improving recognition rate of words that are definitely used by the user in the application. Further, by setting weighting factor for related words which are related with the user words in a user corpus accumulated in the speech recognition system, it is capable of adjusting recognition rate of the related words, thereby improving performance of the speech recognition system. Further, by deciding magnitude of weighting factor through considering at least one of domain correlation, word correlation and time correlation, recognition of words that have high relevance to user words is enhanced, recognition of words that have low relevance to user words is suppressed, and recognition rate of related words can be more precisely adjusted, thereby further improving performance of the speech recognition system.

Speech Recognition Apparatus

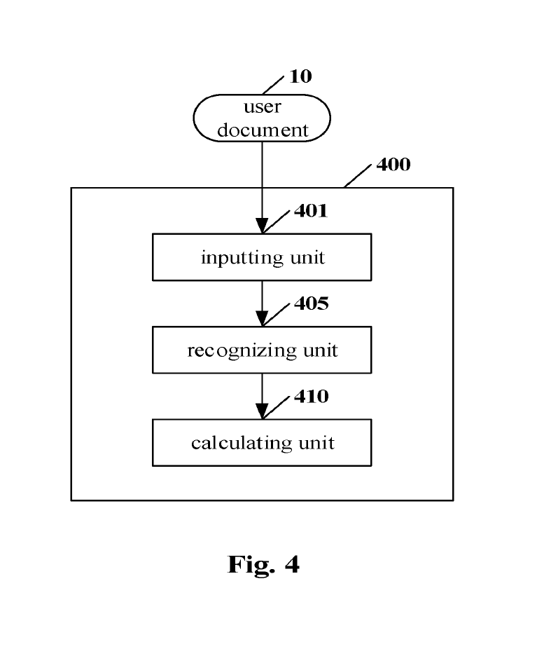

Detailed description is made in the following with reference to FIG. 4. FIG. 4 is a block diagram of a speech recognition apparatus according to an embodiment of the invention.

The speech recognition apparatus 400 of the present embodiment is provided with an inputting unit 401, a recognizing unit 405 and a calculating unit 410.

A speech to be recognized is input by the inputting unit 401.

The speech is recognized into a text sentence by the recognizing unit 405 by using an acoustic model. In the present embodiment, the acoustic model may be any acoustic model known to a person skilled in the art, the unit for recognizing the speech into a text sentence by using an acoustic model may also be any recognition unit known to a person skilled in the art, and the present embodiment has no limitation thereto.

A score of the text sentence is calculated by the calculating unit 410 by using a language model. Here, the language model used by the calculating unit 410 is a language model improved by the apparatus for improving a language model of a speech recognition system.

The speech recognition apparatus of the present embodiment, by using a language model improved by the apparatus for improving a language model of a speech recognition system, is capable of achieving same technical effect as the apparatus for improving a language model of a speech recognition system.

Although a method for improving a language model of a speech recognition system, an apparatus for improving a language model of a speech recognition system, a speech recognition method and a speech recognition apparatus of the present invention have been described in detail through some exemplary embodiments, the above embodiments are not to be exhaustive, and various variations and modifications may be made by those skilled in the art within spirit and scope of the present invention. Therefore, the present invention is not limited to these embodiments, and the scope of which is only defined in the accompany claims.

1. An apparatus for improving a language model of a speech recognition system, comprising:
an extracting unit that extracts user words from a user document provided by a user;
a classifying unit that classifies the user words based on a system lexicon of the speech recognition system; and
a setting unit that sets weighting factor of a probability of the language model for at least one of the user words based on the classified result.

2. The apparatus according to claim 1, wherein,
the classifying unit classifies the user words and words in a user lexicon provided by the user into new words, key words and other words based on the system lexicon and the user lexicon.

3. The apparatus according to claim 2, wherein,
the new words include words which are not included in the system lexicon,
the key words include words which are included both in the system lexicon and the user lexicon,
the other words include words which are included in the system lexicon but not included in the user lexicon.

4. The apparatus according to claim 3, wherein,
the setting unit sets the weighting factor for the new words, key words and other words to be more than 1 respectively.

5. The apparatus according to claim 1, wherein
the setting unit sets weighting factor for related words which are related with the user words in a user corpus accumulated in the speech recognition system.

6. The apparatus according to claim 5, wherein
the setting unit sets weighting factor for the related words based on at least one of domain correlation, word correlation and time correlation.

7. The apparatus according to claim 6, wherein
the higher the domain correlation is, the larger the weighting factor is set,
the higher the word correlation is, the larger the weighting factor is set,
the higher the time correlation is, the larger the weighting factor is set.

8. A speech recognition apparatus, comprising:
an inputting unit that inputs a speech to be recognized;
a recognizing unit that recognizes the speech into a text sentence by using an acoustic model; and
a calculating unit that calculates a score of the text sentence by using a language model;
the language model includes a language model improved by using the apparatus according to claim 1.

9. A method for improving a language model of a speech recognition system, comprising:
extracting user words from a user document provided by a user;
classifying the user words based on a system lexicon of the speech recognition system; and
setting weighting factor of a probability of the language model for at least one of the user words based on the classified result.

10. A speech recognition method, comprising:
inputting a speech to be recognized;
recognizing the speech into a text sentence by using an acoustic model; and
calculating a score of the text sentence by using a language model;
the language model includes a language model improved by using the method according to claim 9.
